(19) United States
(12) Patent Application Publication
(10) Pub. No.: US 2013/0054284 A1
(43) Pub. Date: Feb. 28, 2013

(54) TEMPLATIZED REPORTING ENGINE

(71) Applicants: Robert James Burke, Dallas, TX (US); Brian Alexander Reinhart, Addison, TX (US)

(72) Inventors: Robert James Burke, Dallas, TX (US); Brian Alexander Reinhart, Addison, TX (US)

(21) Appl. No.: 13/219,361

(22) Filed: Aug. 26, 2011

(51) Int. Cl. G06Q 10/00; G06F 17/21

(52) U.S. Cl. 705/7.11; 715/235

(57) ABSTRACT

A system, computer-implemented method, and a computer program product are provided for a templatized reporting engine. A report output request is received. A template is retrieved based on report parameters in the report output request. A data generator based on the template is executed. Data generated by executing the data generator is inserted into the template. The template and the data is output as a report via a user interface.

### CROSS REFERENCE TO RELATED APPLICATIONS

Not applicable

### STATEMENT REGARDING FEDERALLY SPONSORED RESEARCH OR DEVELOPMENT

Not applicable

### REFERENCE TO MICROFICHE APPENDIX

Not applicable

### FIELD OF THE PRESENT DISCLOSURE

The embodiments of the present disclosure relate generally to data reporting, and more specifically to a system, computer-implemented method, and computer program product for a templatized reporting engine.

### BACKGROUND

Energy management systems are complex systems that aggregate information from multiple sub-systems in a customer's facility to provide insight into the customer's energy consumption. Furthermore, a customer may require solutions of increasingly large scale that integrate the customer's Facility Domain seamlessly into the customer's Energy Domain, and finally into the customer's Business Domain.

As used herein, Facility Domain refers to the one or more facility, building, plant, operations platform, etc., consuming energy, and the power uses within such facilities, and expertise specific related to such facility, such as knowledge regarding building management, physical assets, power use, energy power consumption devices, and monitoring tools. A customer will have personnel, whether employees or contractors, with expertise in the Facility Domain, and capable of defining or identifying facility Performance Indicators, referred to as a Facility Manager.

As used herein, Energy Domain refers to energy consumption, use, distribution of use, energy consumption behavior, energy measurement, energy use measurement, key Performance Indicators for a business sector, etc., and the knowledge and expertise specific to such information. An Energy Analyst, or simply “analyst,” is a person, whether employed by a customer, or contracted as an expert, with expertise in the Energy Domain and capable of defining or identifying energy use Performance Indicators.

As used herein, Business Domain refers to business or customer operations, revenue, revenue targets, budgeting, planning, costs, cost goals, etc., and the knowledge and expertise relevant to the business. A customer will have personnel, whether employees or contractors, with expertise in the Business Domain capable of defining or identifying business performance indicators

Energy Resource Management, as used herein, refers to management of energy consumption and its by-products at the Business Domain level.

Business Intelligence as used herein refers to software-based tools used to extract and/or import key Performance Indicators for the business.

A customer, as used herein, is an enterprise, including a business, company, department, an owner of a business, an employee of a business, etc., which desires to have a report detailing identified Performance Indicators and other data regarding energy consumption, etc., as explained herein.

A user, as used herein, refers to a user of the method and/or invention, including the Business Domain and its personnel, and analysts or their personnel.

Performance Indicators, as used herein, refers to data or variables regarding energy consumption, energy resource management, costs, usage, etc. that can be used to generate insights.

Domain Mapping, as used herein, refers to the translation of Performance Indicators from one domain to a set of Performance Indicators in another domain. For example, a business Performance Indicator may be a number of sales per kilowatt hour, while a Facility Manager may only be interested in the average temperature during the same period of sales.

If a customer requests the creation of a customized report, the level of software customization may require tightly integrated participation by the customer in the development process, necessitating a level of software maturity that many software vendors lack. After a long and costly period of trial and error, focusing on generating a large number of reports, the customer may turn instead to identifying and hiring an expensive expert to create the desired report using the customer's reporting tools because many reporting tools are often proprietary and very complex. However, the hired expert may encounter many challenges in mapping the customer's Business Domain to the customer's Energy Domain because such mapping is often non-intuitive, difficult, and highly technical. Subsequently, the deployment of such reports is often complex, time-consuming, error prone, and incorrectly representative of the domain mappings. Furthermore, operational and computational challenges may arise for large quantities of required data. The scalability of an energy management system required for large numbers of deployments creates serious usability issues. Additionally, customers that use the Software as a Service (SaaS) software delivery model often encounter difficulty in integrating the customer's reporting tools and prohibitive costs dues to traditional licensing models.

### SUMMARY

A system, computer-implemented method, and computer program product are provided for a templatized reporting engine, which provide capabilities to customers that contrast with challenges created by software vendors who lack the software maturity to sufficiently integrate a customer into the development process for a customized report and hired experts who incorrectly map a customer's Business Domain to the customer's Energy Domain. A templatized reporting engine provides customers with the capability of customizing their own reports with the assistance of nobody else except an Energy Domain analyst, who may be a customer's employee. When an Energy Domain analyst receives a report creation request from a customer; the analyst identifies data in an Energy Domain based on the report creation request. Since users can use most web browsers and most hypertext markup language (HTML) editors to access the templatized reporting engine, the analyst and/or the customer can create a template based on the report creation request and the identified data. The templatized reporting engine automatically creates a data generator based on the template. Upon receiving a report output request, the templatized reporting engine retrieves the template based on report parameters in the report output request, executes the data generator based on the template, inserts data generated by executing the data generator into the template, and outputs the template and the data as a report. A customer may achieve operational scalability by drastically reducing the development life cycle to create a large number of reports through the elimination of middlemen such as software vendors and reporting tool experts during the development process. Large numbers of customer's employees may cost effectively use the templatized reporting engine to create and generate reports that are integrated with a SaaS software delivery model because the use of the templatized reporting engine is not based on licensing fees for each user.

### BRIEF DESCRIPTION OF THE DRAWINGS

Drawings of the preferred embodiments of the present disclosure are attached hereto so that the embodiments of the present disclosure may be better and more fully understood:

FIG. 1 presents a sample system of the present disclosure;

FIG. 2 presents a sample data store of the present disclosure;

FIG. 3 presents a sample method of the present disclosure.

### DETAILED DESCRIPTION OF SOME EMBODIMENTS

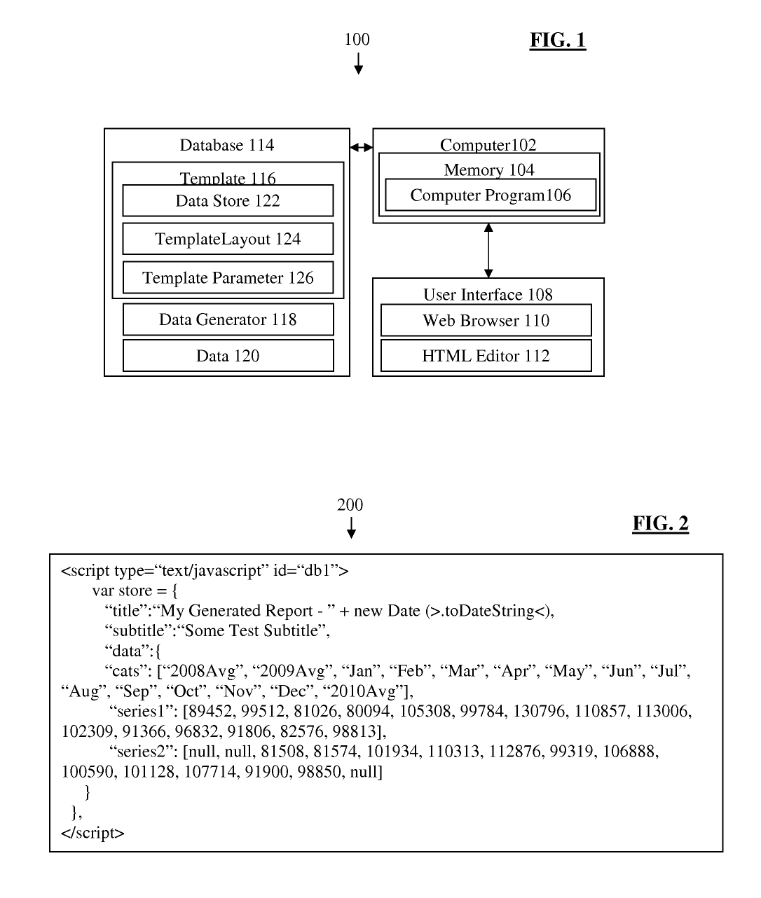

FIG. 1 presents a sample system 100 of the present disclosure, which may also be referred to as an energy management system 100. The system 100 includes a computer 102, a memory 104, a computer program 106, and a user interface 108. The computer program 106 is stored in the memory 104 and executed by the computer 102 to communicate via the user interface 108 with system users, who may also use a web browser 110 and/or a hypertext markup language (HTML) editor 112 to communicate with the computer 102 via the user interface 108.

The computer 102 also communicates with a database 114. The database 114 includes a template 116, a data generator 118, and may include data 120. Additionally or alternatively, the data 120 may reside in another database or other databases, which are not depicted in FIG. 1. The template 116 includes a data store 122, a template layout 124, and template parameters 126. Although FIG. 1 depicts one of each of the elements 102-126, the system 100 may include any number of each of the elements 102-126.

The template 116 uses open standards, such as java script (JS), HTML, java script object notation (JSON), and cascading style sheets (CSS), which may be loaded via the Internet or some other source. This use of open standards ensures that the template 116 is compatible with most types of web browser 110 and most types of HTML editor 112. Therefore, system users may customize reports off-line using their preferred HTML editor 112. During off-line processing, system users may define the look and formatting of the template 116, creating the template 116 themselves or choosing the layout of the template 116 from a set of templates tailored for the customer's unique Business Domain.

The data store 122 functions as an embedded database that is parameterized. An Energy Domain analyst and/or a customer may populate the data store 122 with representative, or sample, data during the process of mapping the customer's Business Domain to the customer's Energy Domain. The realization of the data store 122 in the JSON format effectively parameterizes the data store 122, marking the representative data for complete substitution with live data during the rendering process. An example of a frame 200 of the data store 122 is described below in reference to FIG. 2.

Examples of data in the Business Domain include budgets, corporate energy conservation goals, sales transactions, operational expenses, energy cost, demand cost, transaction and energy cost. Examples of data in the Energy Domain, upon which data in the Business Domain may be based, include calculated data such as real usage, reactive usage, power factor, maximum demand, kilovolt-ampere reactive (kVAr), kilovolt-ampere reactive hours (kVArh), power factor, kilowatts during a base time of use, kilowatts during an intermediate time of use, kilowatts during a sub-peak time of use, kilowatts during a peak time of use, kilowatt hours during a base time of use, kilowatt hours during an intermediate time of use, kilowatt-hours during a sub-peak time of use, and kilowatt hours during a peak time of use. Examples of data in the Facility Domain, upon which the data in the Energy Domain may be based, include raw data such as meter data, meter configuration, real-time data, a sampling frequency, heating ventilation and air conditioning (HVAC) data, lighting data, humidity and, temperature.

The template parameters 126 may include metadata that use the JSON format to define input parameters for requesting a report and the context of the report itself, enabling a system user to easily map the template 116 to a web service's service request. A rendering engine may automatically generate a uniform resource locator (URL) for the template 116 during deployment based on the template parameters 126. The template parameters 126 may also include JSON format parameters that define at least one of an output frequency for the report and a list of potential recipients of the report. For example, the computer program 106 may create parameters that define which users have access to a report and whether the report is automatically generated and output on a daily, weekly, or monthly basis.

The computer program 106 implements a templatized reporting engine to provide capabilities to customers that contrast with challenges that occur with software vendors who lack the software maturity to sufficiently integrate a customer into the development process for a customized report and hired experts who incorrectly map a customer's Business Domain to the customer's Energy Domain. The computer program 106 provides customers with the capability of customizing their own reports with the assistance of nobody else except an Energy Domain analyst, who may be a customer's employee. If the customer has the knowledge of an Energy Domain analyst, the customer may independently create customized reports without the assistance of any Energy Domain analyst.

When an Energy Domain analyst receives a report creation request from the customer; the analyst identifies data in an Energy Domain based on the report creation request. The analyst can work with the customer to map the Energy Domain to the Business Domain quickly, without the need for software vendors or reporting tool experts. System users may perform the mapping process themselves, or use the computer program 106 to facilitate the mapping process by accessing the data 120.

Since the use of open standards such as JS libraries and CSS libraries enable a system user to use almost any web browser 110 and almost any HTML editor 112 to access the computer program 106, the analyst and/or the customer can create the template 116 based on the report creation request and the identified data. When system users create a new template 116 or customize an existing template 116, the computer program 106 specifies the look of the template 116 and the formatting of the template 116. The computer program 106 expedites the report development process because the look of the template 116 and the formatting of the template 116 have the same look as the resulting report and the same formatting as the resulting report. This feature, often referred to as “what you see is what you get,” enables a customer to approve the final version of a report early in the report development life cycle.

The computer program 106 automatically creates the data generator 118 based on the template 116. Rather than use a generic data generator to generate the data requested by every report output request, the computer program 106 creates a particular data generator 118 explicitly for generating the data for the specific template 116. Once the computer program 106 creates an individualized data generator 118 for the template 116, the computer program 106 may create additional customized versions of the template 116 that display the same data as the template 116 through reports of different formats and/or reports of different looks.

The computer program 106 uploads the template 116, links the template 116 to the data generator 118, and maps the template 116 to a web service's service request. While many approaches may be used, one manner of mapping a template to a web service's service request involves creating a URL based on the template parameters 126. For example, the computer program 106 may create a URL that consists of the root of a customer's URL, and URL components that refer to “reports” and the template parameters 126. The specifics of such a URL scheme may change, but could be: [root URL]/report/[location]/[period]/[commodity]. This mapping scheme creates URLs that define the report that may be generated upon their selection. For example, URLs that end with reports/site1zone1/monthly/kilowatthours, reports/site2zone1/monthly/kilowatthours, and reports/site1zone1/monthly/peakkilowatthours may be easily understood by system users as URLs that correspond to reports for the monthly kilowatt hours for site 1 of zone 1, monthly kilowatt hours for site 2 of zone 1, and monthly peak kilowatt hours for site 1 of zone 1. Systems users may easily learn this convention, and quickly determine if a report already exists for monthly peak kilowatt hours for site 2 of zone 1 by simply glancing at a list of URLs provided by the computer program 106 via the user interface 108.

The computer program 106 enables much of the work for the report development process to be accomplished early in the report development life cycle by enabling customers to create their own reports using familiar tools. Customers may need the assistance of nobody other than the customer's Energy Domain analysts, and not a software vendor or a reporting tool expert, to develop reports.

Once the system users have created the template 116, the computer program 106 links the template 116 to the data generator 118, and deploys the template 116 and the data generator 118 to enable the immediate retrieval of the corresponding customized report. The computer program 106 may receive a report output request from a customer via the user interface 108, and may also receive the report output request from business software, a web site, or a scheduling program, which may automatically request a report to be output on a daily, weekly, or monthly basis, for example. Upon receiving a report output request, the computer program 106 verifies that the report parameters specified in the report output request are valid. For example, if a customer uses the user interface 108 to enter the root of the customer's URL followed by reports/site1zone2/monthly/peakkilowatthours, the computer program 106 may return an error message via the user interface 108, specifying that such a report has not yet been created.

The computer program 106 retrieves the template 116 based on report parameters in the report output request. For example, a rendering engine maps a web service's service request to the URL created for the template 116, which enables the computer program 106 to retrieve the template 116 that has been specified by the URL that comprises the report output request. In this example, if a customer uses the user interface 108 to enter the root of the customer's URL followed by reports/site1zone1/monthly/kilowatthours, the computer program 106 retrieves the template 116, which corresponds to the monthly kilowatt hours for site 1 of zone 1.

The computer program 106 executes the data generator 118 based on the template 116. For example, the computer program 106 executes the data generator 118 that the computer program 106 previously created for the template 116 and linked to the template 116, which corresponds to the monthly kilowatt hours for site 1 of zone 1.

The computer program 106 inserts data generated by executing the data generator 118 into the template 116. For example, the computer program 106 executes the data generator 118 that the computer program 106 previously created for the template 116, and inserts the data generated by the execution of the data generator 118 into the template 116, which corresponds to the monthly kilowatt hours for site 1 of zone 1. If the computer program 106 previously loaded the template 116 with sample data to enable system users to sufficiently evaluate the look and the formatting of the corresponding report, the computer program 106 replaces the sample data with the live data generated by the data generator 118. The computer program 106 may also insert a parameter of the report parameters into the template 116. For example, if some report parameters specify a request for a report of the kilowatt usage during the month of January 2010, the computer program 106 inserts these report parameters into the template 116 so that the report that is output will identify the data as depicting kilowatts usage during the month of January 2010.

The computer program 106 identifies any extension specified in the report output request and uses the extension to format the template 116 and its corresponding data in a report format specified by the extension. For example, the extension may specify report formats such as hypertext markup language (HTML) format, portable document file (PDF) format, and comma separated values (CSV) format. The computer program 106 outputs the template 116 and its data via the user interface 108 as a report in response to the report output request. For example, the computer program 106 outputs the template 116, which corresponds to the monthly kilowatt hours for site 1 of zone 1, and its live data via the user interface 108 as a PDF report.

A customer may achieve operational scalability by drastically reducing the development life cycle to create a large number of reports through the elimination of middlemen such as software vendors and reporting tool experts during the development process. Large numbers of a customer's employees may cost effectively use the computer program 106 to generate reports that are integrated with a SaaS software delivery model because the use of the computer program 106 and its associated reports is not based on licensing fees for each user.

FIG. 2 presents a sample frame 200 of a data store 122 presented by the user interface 108 in FIG. 1 of the present disclosure. The frame 200 includes JSON format text for a report that includes average kilowatt usage for the years 2008, 2009, and 2010, and monthly kilowatt usage for 2010. The numerals in the rows that follow “series1” and “series2” are sample data that enable a system user to view an example of a template in an off-line environment, such that the user may see what the template will look like when displayed on-line with live data. After retrieving live data for a template, the templatized reporting engine inserts, or substitutes, the live data for the sample data.

The frame 200 may be part of a larger display screen that includes fields for users to enter commands to create, retrieve, edit, and store the data store 122. The user interface 108 in FIG. 1 may output a display screen that includes the frame 200 in FIG. 2 in response to a search based on search criteria input via the user interface 108 in FIG. 1. For example, a system user may request to review the data store 122 in FIG. 1, which corresponds to the average kilowatt usage data for the years 2008, 2009, and 2010 and the monthly kilowatt usage for 2010.

Because the frame 200 in FIG. 2 is a sample, the frame 200 could vary greatly in appearance. For example, the relative sizes and positioning of the text is not important to the practice of the present disclosure. The frame 200 can be depicted by any visual display, but are preferably depicted by a computer screen. The frame could also be output as a report and printed or saved in electronic format, such as PDF. The frame 200 can be part of a personal computer system and/or a network, and operated from system data received locally, by the network, and/or on the Internet. The frame 200 may be navigable by a user. Typically, a user can employ a touch screen input or a mouse input device to point-and-click to a location on the frame 200 to manage the text on the frame 200, such as a selection that enables a user to edit the text. Alternately, a user can employ directional indicators, or other input devices such as a keyboard. The text depicted by the frame 200 is an example, as the frame 200 may include a much greater amount of text. The frame 200 may also include fields in which a user can input textual information, such as the text for the data store 122 in FIG. 1.

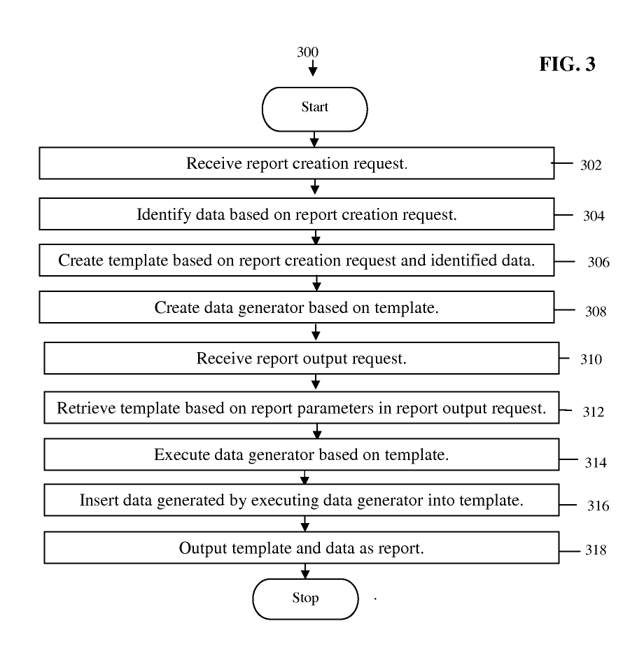

FIG. 3 presents a sample method 300 of the present disclosure. The energy management system 100 in FIG. 1 may execute the method 300 to create a customized report and output the report.

In box 302, a report creation request is received. For example, an analyst uses the computer program 106 to receive a request to create a customized report for the monthly kilowatt hours in zone 1 at site 1, where the request was received from a customer via the user interface 108.

In box 304, data is identified based on a report creation request. For example, an analyst uses the computer program 106 to identify data in an Energy Domain that corresponds to the monthly kilowatt hours in site 1 of zone 1.

In box 306, a template is created based on a report creation request and identified data. For example, an analyst uses the computer program 106 to create the template 116 for the monthly kilowatt hours in site 1 of zone 1 and load the template 116.

In box 308, a data generator is created based on a template. For example, the computer program 106 automatically creates the data generator 118 to retrieve the data in the Energy Domain that corresponds to the monthly kilowatt hours in site 1 of zone 1.

In box 310, a report output request is received. For example, the computer program 106 receives a report request for a report of the monthly kilowatt hours in site 1 of zone 1 from a customer via the user interface 108.

In box 312, a template is retrieved based on report parameters in a report output request. For example, the computer program 106 retrieves the template 116 for the monthly kilowatt hours in site 1 of zone 1.

In box 314, a data generator based on a template is executed. For example, the computer program 106 executes the data generator 118 to retrieve the live Energy Domain data for the monthly kilowatt hours in site 1 of zone 1.

In box 316, data generated by executing a data generator is inserted into a template. For example, the computer program 106 inserts the live Energy Domain data for the monthly kilowatt hours in site 1 of zone 1 data into the template 116.

In box 318, a template and data is output as a report. For example, the computer program 106 outputs the template 116 and its live data as a PDF report for the monthly kilowatt hours in site 1 of zone 1. The method 300 may be repeated as desired. Although this disclosure describes the boxes 302-318 executing in a particular order, the boxes 302-318 may be executed in a different order.

The systems, methods, and computer program products in the embodiments described above are exemplary. Therefore, many details are neither shown nor described. Even though numerous characteristics of the embodiments of the present disclosure have been set forth in the foregoing description, together with details of the structure and function of the present disclosure, the present disclosure is illustrative, such that changes may be made in the detail, especially in matters of shape, size and arrangement of the components within the principles of the present disclosure to the full extent indicated by the broad general meaning of the terms used in the attached claims. The description and drawings of the specific examples above do not point out what an infringement of this patent would be, but are to provide at least one explanation of how to make and use the present disclosure. The limits of the embodiments of the present disclosure and the bounds of the patent protection are measured by and defined in the following claims.

1. A system for a templatized reporting engine, the system including:
a computer;
a memory;
a user interface; and
a computer program stored in the memory and executable by the computer to:
receive a report output request,
retrieve a template based on report parameters in the report output request,
execute a data generator based on the template,
insert data generated by executing the data generator into the template, and
output, via the user interface, the template and the data as a report.

2. A system as in claim 1, wherein the report output request is received from at least one of a scheduling computer program, business software, a web site, and the user interface.

3. A system as in claim 1, wherein the computer program is further executable to output an error message via the user interface in response to a determination that at least one of the report parameters are invalid.

4. A system as in claim 1, wherein the data generator is associated with a Java script object notation (JSON) format data store.

5. A system as in claim 1, wherein the computer program is further executable to insert a parameter of the report parameters into the template, and output, via the user interface, the template and the data and the parameter.

6. A system as in claim 1, wherein the template is output in a format specified by at least one of the report parameters.

7. A system as in claim 6, wherein the format is at least one of a hypertext markup language (HTML) format, a portable document file (PDF) format, and a comma separated values (CSV) format.

8. A computer-implemented method for a templatized reporting engine, the method including the steps of:
receiving, by a computer program stored in a memory and executed by a computer, a report creation request via a user interface;
identifying data based on the report creation request;
creating, by the computer program, a template based on the report creation request and the identified data;
creating, by the computer program, a data generator based on the template;
receiving, by the computer program, a report output request;
retrieving, by the computer program, the template based on report parameters in the report output request,
executing, by the computer program, the data generator based on the template,
inserting, by the computer program, data generated by executing the data generator into the template, and
outputting, by the computer program via the user interface, the template and the data as a report.

9. A computer-implemented method as in claim 8, wherein identifying the data is by at least one of the computer program and an analyst who is familiar with the data which is in an energy domain.

10. A computer program product for a templatized reporting engine, the computer program product including:
a computer readable storage medium storing computer executable program code that, when executed by a processor, causes the computer executable program code to perform a method including the steps of:
receiving a report creation request via a user interface;
identifying data based on the report creation request;
creating a template based on the report creation request and the identified data;
creating a data generator based on the template;
receiving a report output request; and
outputting, via the user interface, the template and data generated by executing the data generator as a report.

11. A computer program product as in claim 10, wherein the report creation request is associated with a business domain.

12. A computer program product as in claim 11, wherein the business domain includes data associated with at least one of a budges, a corporate energy conservation goal, a sales transaction, an operational expense, an energy cost, a demand cost, and a transaction energy cost.

13. A computer program product as in claim 10, wherein the data is associated with an energy domain, and is based on data in a facility domain.

14. A computer program product as in claim 13, wherein the energy domain includes data for at least one of real usage, reactive usage, power factor, maximum demand, kilovolt-ampere reactive (kVAr), kilovolt-ampere reactive hours (kVArh), power factor, kilowatts during a base time of use, kilowatts during an intermediate time of use, kilowatts during a sub-peak time of use, kilowatts during a peak time of use, kilowatt hours during a base time of use, kilowatt hours during an intermediate time of use, kilowatt-hours during a sub-peak time of use, and kilowatt hours during a peak time of use.

15. A computer program product as in claim 13, wherein the facility domain includes data that is associated with at least one of a meter, a meter configuration, real-time data, a sampling frequency, heating ventilation and air conditioning (HVAC), lighting, humidity, and temperature.

16. A computer program product as in claim 10, wherein creating the template includes editing by a hypertext markup language (HTML) editor.

17. A computer program product as in claim 10, wherein creating the template includes creating metadata associated with the template.

18. A computer program product as in claim 10, wherein creating the template includes creating at least one of a look of the report and a formatting of the report.

19. A computer program product as in claim 18, wherein the template is based on a cascading style sheets (CSS) template.

20. A computer program product as in claim 10, wherein creating the template includes creating parameters that define at least one of an output frequency for the report and a list of potential recipients of the report.
